(19) United States
(12) Patent Application Publication
(10) Pub. No.: US 2018/0104598 A1
(43) Pub. Date: Apr. 19, 2018

(54) GAME MACHINE AND PROCESS

(71) Applicant: JRTR Software, LLC, Passaic, NJ (US)

(72) Inventors: James H. Robbins, Verona, NJ (US); Thomas J. Rademaker, Montclair, NJ (US)

(21) Appl. No.: 15/292,984

(22) Filed: Oct. 13, 2016

(51) Int. Cl. A63F 13/828; A63F 13/35; A63F 13/92; A63F 13/79; A63F 13/46; A63F 13/25; A63F 13/327

(52) U.S. Cl. CPC A63F 13/828; A63F 13/35; A63F 13/92; A63F 13/327; A63F 13/46; A63F 13/25; A63F 13/79

(57) ABSTRACT

A smartphone has an application to play a fantasy sports game at a specific location, the fantasy sports game being under control of a server. The fantasy sports game uses data obtained from a second server that is updated based on a real-life sports game being played. The server uses a subset of data from the second server to determine a winner of the game. Other smartphones at the specific location also compete in the fantasy sport game. The server uses a subset of data from the second server to determine a winner of the fantasy sports game.

### FIELD OF THE INVENTION

Aspects of the present relate to systems and methods to play a game on a smartphone or wireless tablet computer. The game is preferably a sports game and more preferably related to a fantasy sports game.

### BACKGROUND OF THE INVENTION

Fantasy games are hosted on servers. They commonly use data derived from games that are being played with actual players. The performance of the players is rated with a score that is preferably objective. The score is attached to or associated with a specific player. A fantasy game player creates on a computing device a team with a number of players, which may be from different teams. The team is associated with an account of the fantasy game player and the names of the players in the team in the fantasy game is stored on a server. When actual games are being played, scores of the performance of actual players in the actual teams are being determined and stored to the server. The account of the fantasy game player has access to those scores on the server. A computer program on the server updates the score of the team players in the fantasy game after the scores of those players in real-life are being achieved on the sports field.

Fantasy games are very popular. They allow a fantasy game player to assemble a fantasy game team from real-life players who in real-life play in different teams. The score of a fantasy game team is based on the real-life performance of real-life players who in real-life may or may not be on the same team. While real sports teams are conventional, fantasy games are non-conventional as they use the actual performance of real-life players to determine the score of a fantasy team of players who are not all in real-life team members. One may call fantasy games also simulation games, as they simulate a performance that is not really taking place.

Fantasy game players take their sport very serious and often perform a considerable amount of research before they select a team. In many cases most of the fantasy team members are maintained on the fantasy team during a season.

While providing great pleasure to hard-core fantasy team players, the above approach does not lend itself to an easy and fun game that can be played in a bar or other social setting that does not facilitate deep analysis and long term strategy.

Accordingly, improved and novel apparatus and methods to play a fantasy game are required.

### DESCRIPTION OF THE DRAWINGS

FIG. 1 illustrates a network in accordance with one aspect of the present invention.

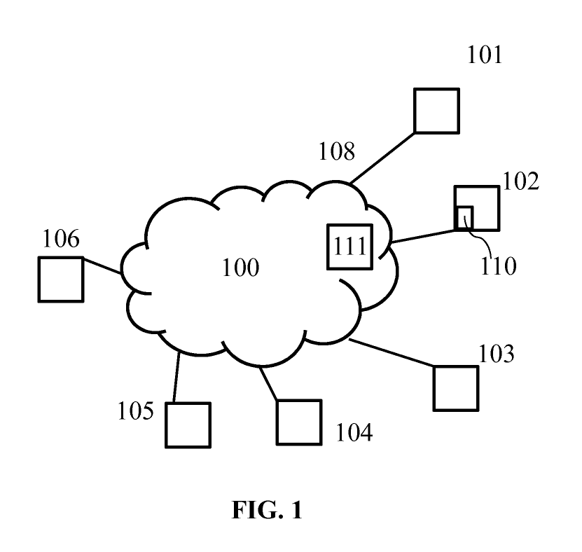

FIG. 2 illustrates a computing device in accordance with an aspect of the present invention.

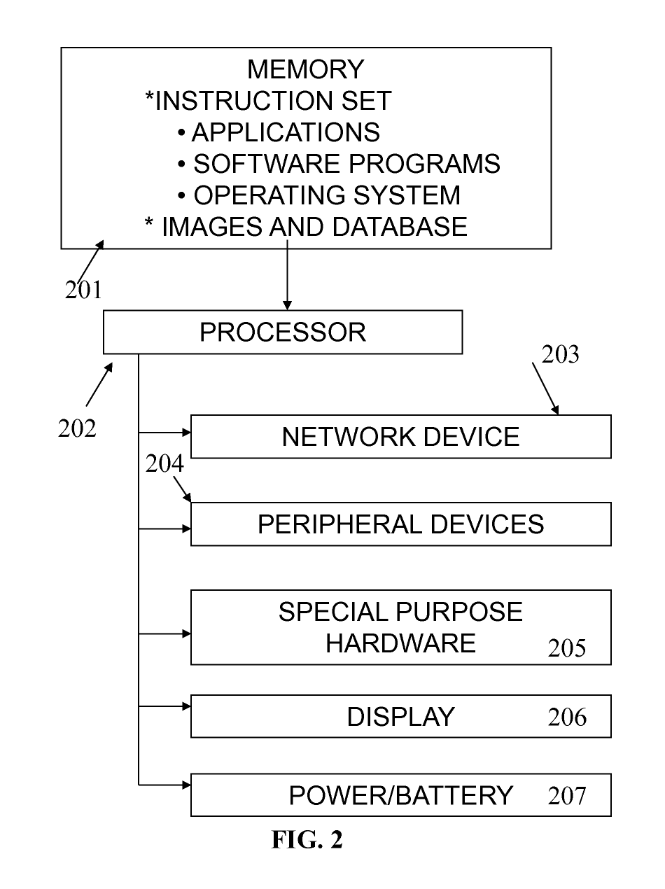

FIG. 3 illustrates an arrangement of computing devices in accordance with various aspects of the present invention.

FIG. 4 illustrates steps in accordance with various aspects of the present invention.

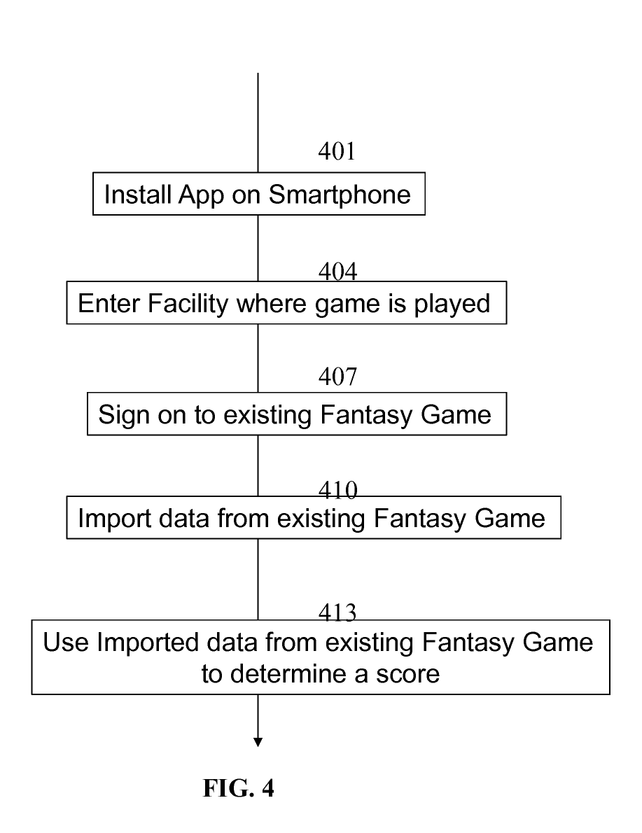

### DESCRIPTION OF THE PREFERRED EMBODIMENT

Aspects of the present invention relate to a portable computing machine to play an easy fantasy game based on real-life games and game players.

Aspects of the present invention relate to a machine, a smartphone, to play a fantasy game. The smartphone is the fantasy game machine. The operator of the smartphone who plays the fantasy game is a fantasy game player. The fantasy game is based on one or more sports games played by real-life players in real-life games. When using the words game and player without additional characteristics, real-life game and real-life player are intended to distinguish from the fantasy game and the fantasy player.

A smartphone herein is a portable and mobile wireless device with a processor, memory and a display which is preferable a touch screen. Generally a smartphone includes a GPS system that generates GPS coordinates of a location of the smartphone. The smartphone has a housing. The smartphone is enabled to connect via an antenna with a cellphone network. In general a smartphone also has capability to connect directly to a network such as a WiFi or Bluetooth network. The memory is enabled to store instructions and data, among which as apps or applications. The smartphone in general also has a camera and a microphone and a loudspeaker. The smartphone is enabled to connect and exchange data with other computing devices, including other mobile and wireless computing devices.

In accordance with an aspect of the present invention a computer based game called Fantasy Ticket is provided that is a mobile application that will run on iOS and Android devices. There are 2 user groups for this application, fantasy game players and sports bars (referred to as location subscribers or just subscribers going forward). Fantasy game players will create a Fantasy Ticket account. In the process of creating an account they will link their Fantasy Ticket account to an existing Fantasy Game account, for instance an ESPN® account or a Yahoo® ® account. Linking to this account will allow a separate Fantasy Ticket server to get the fantasy team info from each fantasy game player's fantasy team created in their original Fantasy Game account. After creating a Fantasy Ticket account, for instance on a smartphone and logging in the player will be presented with a list of nearby locations that are available to play Fantasy Ticket games. In one embodiment of the present invention an application related to the Fantasy Ticket game is installed on the smartphone.

The app on the smartphone performs several functions. It maintains contact with the server for instance over a WiFi or a wireless cell phone connection and it receives updates of locations or bars where Fantasy Ticket games are being played. Based on GPS coordinates of a GPS system on the smartphone provided to the server, the server provides data to the smartphone that identifies locations near the smartphone where Fantasy Ticket games are being played.

Based on a profile of the user, other details may be provided related to the location. For instance what type of food or drinks is being served, a number of Fantasy Ticket players currently active in at the location and the type of sports that are being played and other relevant data. When a player enters one of these locations they can “check in” and begin playing the games available at that location.

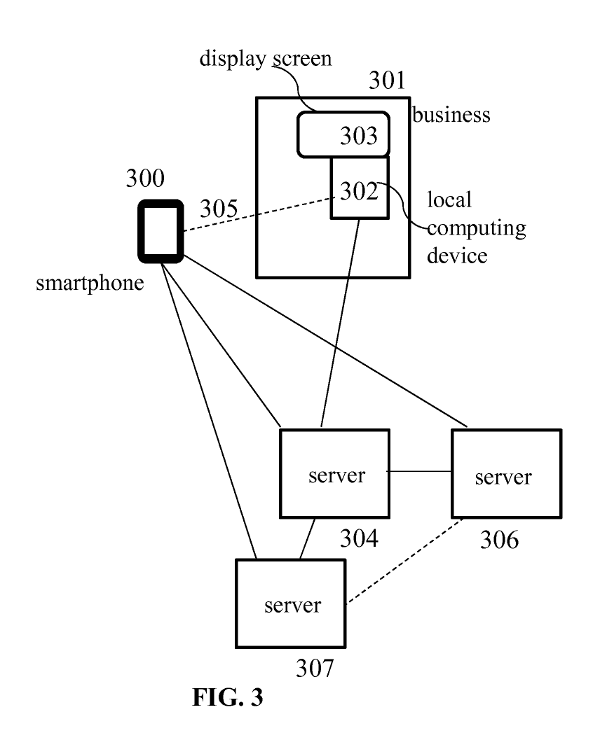

This is illustrated in FIG. 3. A user has a smartphone 300 that includes a GPS system and on a memory the Fantasy Ticket app, which is activated. The smartphone 300 is connected to a server 304 over a network which includes wireless connections. The server 304 manages aspects of the Fantasy Ticket game, including membership and participants. A business operating at a facility 301 has a computing device 302 that is also connected to the server 304. The smartphone 300 provides an alert that facility 301 operates a Fantasy Ticket game and provides further information, for instance how many devices are active in Fantasy Ticket game at the facility. The alert may provide an offer to entice the user of 300 to enter, such as a free drink. The device 302 in one embodiment of the present invention has WiFi or other locally operating wireless equipment that allows locally present devices to connect directly wirelessly via a connection 305 to 302 without incurring network cost and connect via 302 to 304.

The rules of the Fantasy Ticket game itself are implemented and run in at least two different embodiments. In a first embodiment of the present invention the game is executed on server 304. The server 304 maintains records of devices that are checked in to play the game and determine scores of all devices that are playing. It provides scores of the playing smartphones at the facility, based on their GPS position, for display on a display screen 303 connected to 302. In another embodiment of the present invention the game is played on device 302. The device 302 gets all relevant data via server 304 from another server 306. In yet a further embodiment of the present invention the rules of the game are implemented on device 302 and relevant information is provided by smartphone 300 which obtains it from server 306.

The Fantasy Ticket game is related to traditional fantasy games but has much simpler rules. Games can include but are not limited to: Highest score per game: Highest fantasy score for any NFL players on a team that play during a particular game. Example: Giants vs Cowboys is the game. The user only gets points for any player they have on either of those 2 teams. All other players on their team does not get them points for the Giants vs Cowboys game. Highest total score for the day: Highest total fantasy score for all NFL players on team that played on a given day. This means that if a player plays on Thursday or Monday, then their fantasy points don't count towards this game if it is a Sunday. Longest run of day: Compare running back run distances for each running back a user has on their team. The user with the longest run wins. Includes Thursday and Sunday games but excludes Monday night games. Longest pass of day: Compare quarterback throw distances for each QB a user has on their team. The user with the longest throw wins. Includes Thursday and Sunday games but excludes Monday night games. Longest catch of day: Compare receivers' catch distances for each receiver a user has on their team. The user with the longest catch wins. Includes Thursday and Sunday games but excludes Monday night games. Longest Field goal of the day: Compare kickers' field goal distances for each kicker a user has on their team. The user with the longest field goal wins. Includes Thursday and Sunday games but excludes Monday night games. Best defense for the day: Best fantasy defense score for the day. Includes Thursday and Sunday games but excludes Monday night games. Overall highest score for the week: (Must be present for Monday night game to win) Highest overall fantasy score for the week. Includes entire team from Thursday through Monday night. Must be present on for Monday night game to win. Special Monday night games: All games listed above but just for Monday night game.

The user of smartphone 300 has an account for an existing Fantasy Game on server 306. This server 306 updates all subscribers' teams as real-life games are being played. The device 302 uses a limited amount of that data in executing its rules. In order to obtain that data a user of a device 300 at a location 301 signs up for an account at server 304 and allows that account to access the data of the user's account at 306. In the alternative, a user of device 300 connects to server 306 for an established Fantasy Game account and at the same time connects to 303, if so desired through 302. The app as installed on 300 is connected to 302 or 304 and is informed of the type of Fantasy Ticket game that is being played and the data that is required to play the Fantasy Ticket game. It extracts the required data that is needed by 302 or 304 from data provided or updated by 306 and provides the updated data to 302 or 304. One may say that the Fantasy Ticket game is a game that is played within a known Fantasy Game, as a game-within-a game.

In one or more embodiments, a real-time scores and stats server 307 may be connected to and provide data to the sever 304 and/or device 300 on the real-life game performance of real-life players. The real-time scores and stats server 307 may also be connected to and provide data to the existing Fantasy Game server 306. The data obtained from real-time scores and stats server 307 may be used to calculate the fantasy points on server 304.

Location owners can offer coupons and/or prizes to the winners of each game. Players can only play at one location at a time; if a player “checks in” to a new location they will be automatically removed from all games in progress at any other location. All of these features are available for free to the players. Revenue for the Fantasy Ticket game service will come in the form of advertisements in the applications. Ads may include but are not limited to national or local ads, and may be placed at the bottom of the app or be temporarily full screen. They may be text, images, video, or a combination.

Location subscribers will use the iOS and Android apps for scanning coupon QR codes. They will interact with the rest of the system via a web app. This web app will allow the subscribers to set coupons and prizes for the games they offer at their location and it will allow them to choose the games to offer. They will also have statistics about who is coming to their location to play. The subscribers will be able to send out a push notification, once a week, to the players who have visited their location within the past week, reminding them to come back and play again. Any location can be used to play Fantasy Ticket, but in order to get the subscriber perks, subscribers must sign up and pay a fee each season.

In accordance with one embodiment of the present invention a fantasy sport game is played on a computing device with a processor and a memory which is preferably a smartphone. A first computing device accesses a first server over a network and creates a new account on the first server. The new account is linked to an existing account on a second server. The second server stores and updates a fantasy sports team that is associated with the existing account. Updates on the second server take place when or shortly after a real-life sports game is played. The first server in an embodiment of the present invention accesses data of the existing account to obtain updated information on the fantasy sports team. In another embodiment of the present invention an application is stored on the smartphone. The application obtains old and updated information of the fantasy game team from the second server as it relates to the existing account's fantasy team. Preferably no other data is obtained by the smartphone from the second server. The data including the updated data or part thereof is provided by the smartphone to the first server. This indicates to the first server in which type of Fantasy Ticket game the smartphone can participate. If one Fantasy Ticket game relates to a real-life Giants vs. Cowboys football game and the fantasy team on the second server related to the account has no players of either the Giants or Cowboys then participation in the Fantasy Ticket game is moot. However, if the fantasy game of the account includes players of the Giants and/or Cowboys then participation in the Fantasy Ticket game is possible.

The first server sends to a second computing device a list of locations that are available to play one or more of a plurality of games and the second computing device. The server monitors a location of the second computing device and allows a Fantasy Ticket game to be played on the second computing device when the computing device is at one of the locations that are available to play one or more of the plurality of games.

In an embodiment of the present invention a mobile computing device or smartphone displays the list of locations. The app will determine the user's location based on the smartphone GPS. The location will be sent to the server from the phone and then a list of bars nearby determined by the GPS coordinates of the smartphone will be sent back to the phone from the server. In one embodiment of the present invention the listed bars preferably will be within a radius of 500 meter of the smartphone, more preferably within a radius of 300 meter and most preferably within a radius of 150 meter. This list of bars will only include bars that participate with our service. The app will have the ability to provide directions to a bar in the list of nearby locations.

In an embodiment of the present invention a mobile computing device or smartphone includes the rules of the Fantasy Ticket game. This includes displaying the rules of the particular game being played and a list of all users' scores and their current leaderboard position.

In an embodiment of the present invention the server causes a plurality of games that can be played on a display on the mobile computing device or smartphone, the plurality of games including the Fantasy Ticket game, wherein the smartphone selects the Fantasy Ticket game from the plurality of games.

In accordance with an embodiment of the present invention one or more additional accounts are created on the first server, each of the one or more additional accounts are linked to an additional second computing device or smartphone and to an additional existing account, an additional fantasy sports team being associated with each of the one or more additional accounts.

In accordance with an embodiment of the present invention the server monitors a location of the one or more additional second computing devices or smartphones by their generated GPS coordinates and allows the Fantasy Ticket game to be played on each of the additional second computing devices or smartphones when the additional second computing device or smartphone is at one of the locations that are available to play one or more of the plurality of games and the server which may be the first server determines which of the second computing devices or smartphones are at a selected location.

The server also determines which of the second computing devices or smartphones located at the selected location wins the Fantasy Ticket game. Each of the second computing devices or smartphones located at the selected location has an account or access to an account for a standard fantasy game on a second server connected to at least one of the server or the second computing device or smartphone.

An account herein are credentials or codes or the like that allow access to data stored on a device or a database. In general an account comprises a user name and a password. A first device gets access to data associated with an account on a second device, in general when the first device provides signals corresponding to the correct user name and password or PIN (personal identification number). When the second device recognizes or accepts these signals, data associated with the account or the credential are made available by the second device to the first device.

In accordance with an embodiment of the present invention the server sends a coupon such as a digital coupon or a prize to the second computing device that won the game.

In accordance with an embodiment of the present invention the server allows a second computing device to play the game at one location at a time. When a game is played from a smartphone at a first location, the server may assign a unique identification number to that game. The user in that case can not continue playing the game or replay the game at a different location. This prevents cheating and protects the investment of the owner of the location in acquiring a patron and enabling playing the game.

In accordance with an embodiment of the present invention a user sets up an account on a first computing device, which may be a personal computer, a tablet, a laptop computer, or a smartphone and plays the game on a second computing device which is preferably a portable, mobile and wireless computing device such as a smartphone. In one embodiment the first and second devices are different devices and in yet another embodiment the first and second devices are the same device.

In accordance with an embodiment of the present invention, if a second computing device checks in to a new location, then the server removes all games in progress on the second computing device from any other location. This assures that a smartphone can play a Fantasy Ticket game only at one location.

In accordance with an embodiment of the present invention, the second computing devices are mobile devices or smartphones running iOS, Android, or Windows applications.

In accordance with an embodiment of the present invention the server periodically sends out a push notification to second computing devices or smartphones that have been at one of the locations. For instance, the bar owners will have the ability to send out 1 push notification per week to users' smartphones who were at that location the previous week. The push notification may be a commercial message with an invitation to visit again.

In accordance with an embodiment of the present invention, the server accesses all accounts associated with each of the second computing devices or smartphones at a selected location and analyzes each fantasy sports team associated with the second computing device or smartphone at the selected location to determine a winner of the game. In the alternative, the server requests the information of all participating second computing devices or smartphones at a selected location to determine a winner.

In accordance with an embodiment of the present invention, the server analyzes the fantasy sports teams associated with each of the second computing devices or smartphones at a selected location to determine which fantasy sports team includes a player that played in a real game played during a selected time period that had the highest score of all real games played during the selected time period.

In accordance with an embodiment of the present invention, the game is limited to a real sports game that is played in a predefined timeframe. For instance, the National Football League (NFL) has 5 timeframes when a game may be on. Thursday night, Sunday at 1, 4, and 8:30 and Monday night. So for example, the Sunday 1 pm timeframe may have 6 real games being played.

In accordance with an embodiment of the present invention the game is limited to one real-life game timeslot which can comprise of multiple real sports games. In one embodiment of the present invention the real-life sport is American Football.

In another embodiment of the present invention, the game is limited to a specified timeframe within the real sports game that is played. For example, in one embodiment, the game is limited to one quarter or one half of a real-life American Football game.

In accordance with an embodiment of the present invention, the server analyzes the fantasy sports teams associated with each of the second computing devices or smartphones at a selected location to determine which fantasy sports team includes a group of players that played in a real game played during a selected time period that had the highest score aggregate score of all real games played during the selected time period.

In accordance with an embodiment of the present invention, the server analyzes the fantasy sports teams associated with each of the second computing devices at a selected location to determine which fantasy sports team includes a group of player that played in a real game played during a selected time period that had the longest run during all real games played during the selected time period.

In accordance with an embodiment of the present invention, the server analyzes the fantasy sports teams associated with each of the second computing devices at a selected location to determine which fantasy sports team includes a group of player that played in a real game played during a selected time period that had the longest pass during all real games played during the selected time period.

In accordance with an embodiment of the present invention, the server analyzes the fantasy sports teams associated with each of the second computing devices or smartphones at a selected location to determine which fantasy sports team includes a group of player that played in a real game played during a selected time period that had the longest catch during all real games played during the selected time period.

In accordance with an embodiment of the present invention, the server analyzes the fantasy sports teams associated with each of the second computing devices at a selected location to determine which fantasy sports team includes a group of player that played in a real game played during a selected time period that had the longest field goal during all real games played during the selected time period.

In accordance with an embodiment of the present invention, the server analyzes the fantasy sports teams associated with each of the second computing devices or smartphones at a selected location to determine which fantasy sports team includes a group of player that played in a real game played during a selected time period that had the defense during all real games played during the selected time period. This information is obtained from the second server wherein all data related to real-time games are stored.

While the examples of various embodiments described above use American Football as the exemplary sport, it will be understood that various other real-life sporting events can provide the basis for various types of fantasy games within the scope of the specification and appended claims.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A method of playing a fantasy sport game, comprising:
using a first computing device to access a server and create an account on the server and to link the account to an existing account on a different server, a fantasy sports team being associated with the existing account;
the server accessing data of the existing account to obtain information on the fantasy sports team;
the server sending to a second computing device a list of locations that are available to play one or more of a plurality of games on the second computing device;
the server monitoring a location of the second computing device and allowing a fantasy game to be played on the second computing device when the computing device is at one of the locations that are available to play one or more of the plurality of games.

2. The method of claim 1, comprising the second computing device displaying the list of locations.

3. The method claim 1, comprising the second computing device displaying the fantasy game, including displaying the rules of the particular game being played and a list of all users' scores and their current leaderboard position.

4. The method of claim 1, wherein the second computing device is a portable device.

5. The method of claim 1, comprising:
the server providing a plurality of games that can be played on the second computing device, the plurality of games including the game; and
the second computing device selecting the game from the plurality of games.

6. The method of claim 1, comprising:
creating one or more additional accounts on the server, each of the one or more additional accounts linked to an additional second computing device and to an additional existing account, an additional fantasy sports team being associated with each of the one or more additional accounts;
the server monitoring a location of the one or more additional second computing devices and allowing the game to be played on each of the additional second computing devices when the additional second computing device is at one of the locations that are available to play one or more of the plurality of games;
the server determining which second computing devices are at a selected location; and
the server determining which of the second computing devices located at the selected location won the game.

7. The method of claim 6, comprising the server sending a coupon or a prize to the second computing device that won the game.

8. The method of claim 6, comprising the server allowing a second computing device to play the game at one location at a time,

9. The method of claim 8, if a second computing device checks in to a new location, then the second server removes all games in progress on the second computing device from any other location.

10. The method of claim 6, wherein the second computing devices are mobile devices running iOS and Android applications.

11. The method of claim 6, comprising the server periodically sending out a push notification to second computing devices that have been at one of the locations.

12. The method of claim 6, comprising the server accessing all accounts associated with each of the second computing devices at a selected location and analyzing each fantasy sports team associated with the second computing device at the selected location to determine a winner of the game.

13. The method of claim 6, comprising the server analyzing the fantasy sports teams associated with each of the second computing devices at a selected location to determine which fantasy sports team includes a player that played in a real game played during a selected time period that had the highest score of all real games played during the selected time period.

14. The method of claim 12, wherein the game is limited to a timeframe of a real sports game.

15. The method of claim 12, comprising the server analyzing the fantasy sports teams associated with each of the second computing devices at a selected location to determine which fantasy sports team includes a group of player that played in a real game played during a selected time period that had the highest score aggregate score of all real games played during the selected time period.

16. The method of claim 12, comprising the server analyzing the fantasy sports teams associated with each of the second computing devices at a selected location to determine which fantasy sports team includes a group of player that played in a real game played during a selected time period that had the longest run during all real games played during the selected time period.

17. The method of claim 12, comprising the server analyzing the fantasy sports teams associated with each of the second computing devices at a selected location to determine which fantasy sports team includes a group of player that played in a real game played during a selected time period that had the longest pass during all real games played during the selected time period.

18. The method of claim 12, comprising the server analyzing the fantasy sports teams associated with each of the second computing devices at a selected location to determine which fantasy sports team includes a group of player that played in a real game played during a selected time period that had the longest catch during all real games played during the selected time period.

19. The method of claim 12, comprising the server analyzing the fantasy sports teams associated with each of the second computing devices at a selected location to determine which fantasy sports team includes a group of player that played in a real game played during a selected time period that had the longest field goal during all real games played during the selected time period.

20. The method of claim 12, comprising the server analyzing the fantasy sports teams associated with each of the second computing devices at a selected location to determine which fantasy sports team includes a group of player that played in a real game played during a selected time period that had the defense during all real games played during the selected time period.

21. The method of claim 1, wherein the first computing device and the second computing devices are the same devices.
